(19) United States
(12) Patent Application Publication
(10) Pub. No.: US 2024/0403093 A1
(43) Pub. Date: Dec. 5, 2024

(54) OBJECT STORAGE SERVICE LEVERAGING DATASTORE CAPACITY

(71) Applicant: VMware, Inc., Palo Alto, CA (US)

(72) Inventors: Yang Yang, Shanghai (CN); Xiang Yu, Shanghai (CN); Xiaohua Fan, Shanghai (CN); Jin Feng, Shanghai (CN)

(21) Appl. No.: 18/204,481

(22) Filed: Jun. 1, 2023

(51) Int. Cl. G06F 9/455; G06F 9/54

(52) U.S. Cl. CPC G06F 9/45558; G06F 9/547; G06F 2009/45583; G06F 2009/45595

(57) ABSTRACT

The disclosure provides a method for exposing object storage as a service. The method generally includes receiving, by an object service proxy provisioned for providing the service, a request to access a first object in an object store, wherein the object store leverages a percentage of datastore capacity for a datastore, determining, by the object service proxy, both of: an identifier of a container in the object store comprising the first object and an internet protocol (IP) address associated with an object protocol service provisioned to access the container comprising the first object, re-directing, by the object service proxy, the request to access the first object to the object protocol service using the IP address associated with the object protocol service, wherein the request comprises the identifier of the container and in response to re-directing the request, receiving the first object from the object protocol service.

In recent years, cloud-based software has been progressively replacing on-premise software as the preferred deployment option. Software as a service (SaaS) is a software distribution model in which a cloud provider (e.g., Amazon Web Services (AWS)) hosts applications and makes them available to end users over the internet. In this model, an independent software vendor (ISV) may contract a third-party cloud provider (1) to host the ISV's applications and related data in the cloud provider's data center or (2) to host the ISV's program and associated data using the ISV's host computers, storage, networking, and computing resources in the cloud.

SaaS applications and services may use a multi-tenant approach, which means a single instance of a SaaS application may be running on the host computers, and that single instance will serve each subscribing customer or cloud tenant. The application will run on a single version and configuration across all customers, or tenants. Though different subscribing customers will run on the same cloud instance with a common infrastructure and platform, the data from different customers will still be segregated. Because SaaS applications are delivered over the internet, users can access SaaS application using any device with a network connection, at any time.

In some implementations, a software defined data center (SDDC) stack is implemented in the cloud to take advantage of cloud-based services. Unlike a traditional data center, in an SDDC, infrastructure elements are virtualized and delivered as a service. Networking, storage, processing, and security functions can execute as virtualized components on top of physical hardware devices. For example, an SDDC may include clusters of physical servers (e.g., hosts) that are virtualized and managed by virtualization management servers. Each server can include a virtualization layer (e.g., a hypervisor) that provides a software abstraction of the hardware platform of the physical server (e.g., central processing unit (CPU), random access memory (RAM), storage, network interface card (NIC), etc.) to allow multiple virtual computing instances (e.g., such as virtual machines (VMs)) to run thereon. Local storage resources of the hosts may be housed in or directly attached (hereinafter, use of the term “housed” or “housed in” may be used to encompass both housed in or otherwise directly attached) to the hosts. In certain embodiments, local storage resources of hosts belonging to a host cluster are leveraged to provide an aggregate object-based store to the VMs running on the hosts in the cluster. The distributed object-based store may be a virtual storage area network (VSAN). VSAN is configured to store data, received from multiple users (e.g., VMs of clients), in the form of flexible data containers called objects. Objects represent blocks of data within VSAN and may include, for example, file system objects that contain VM configuration files and/or virtual disk descriptor files, virtual disk objects that are accessed by the VMs during runtime, and/or the like.

An example SDDC, made commercially available by VMware, Inc. of Palo Alto, CA, is a fully integrated stack of hardware and software which consists of at least, vSphere, NSX, and vSAN offerings also provided by VMware, Inc. vSphere is VMware's virtualization platform that includes a hypervisor and virtualization management software. NSX is VMware's network virtualization and security platform that enables a virtual cloud network, a software-defined approach to networking that extends across data centers, clouds, and application frameworks. vSAN is VMware's storage virtualization software that supports hyper-converged infrastructure (HCl).

It should be noted that the information included in the Background section herein is simply meant to provide a reference for the discussion of certain embodiments in the Detailed Description. None of the information included in this Background should be considered as an admission of prior art.

### SUMMARY

One or more embodiments provide a method for exposing object storage as a service. The method generally includes receiving, by an object service proxy provisioned for providing the service, a request to access a first object in an object store, wherein the object store leverages a percentage of datastore capacity for a datastore. The method further includes determining, by the object service proxy, an identifier of a container in the object store comprising the first object. The method further includes determining, by the object service proxy, an internet protocol (IP) address associated with an object protocol service provisioned to access the container comprising the first object. The method further includes re-directing, by the object service proxy, the request to access the first object to the object protocol service using the IP address associated with the object protocol service, wherein the request comprises the identifier of the container. The method further includes, in response to re-directing the request to the object service proxy, receiving the first object from the object protocol service.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1 illustrates example physical and virtual network components in a networking environment in which embodiments of the present disclosure may be implemented.

FIG. 2 is a flow diagram illustrating example operations for provisioning an object storage service for virtual storage area network (VSAN)-based host clusters in a data center, according to an example embodiment of the present disclosure.

FIG. 3A is a flow diagram illustrating example operations for accessing objects in a VSAN via an object storage service, according to an example embodiment of the present disclosure.

FIG. 3B illustrates an example architecture for accessing objects in a VSAN via the object storage service, according to an example embodiment of the present disclosure.

FIG. 4 is a flow diagram illustrating example operations for creating objects in VSAN via an object storage service, according to an example embodiment of the present disclosure.

FIG. 5 is a workflow illustrating example operations for load balancing of objects across object stores in a data center, according to an example embodiment of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Implementation of a software defined data center (SDDC) stack on cloud dedicated infrastructure may allow for an object storage service to be developed and implemented for exposing use of the data center's object storage as a service. Exposing use of the object storage as a service may allow any user (using any device with a network connection) to make a request to the underlying storage, for example, to write and/or read data stored in the object storage as objects, at any time. The object storage service may allow a user to make this request without having knowledge of the underlying file system used for storing objects in the object storage. However, existing SDDCs may not have such functionality (e.g., object storage services) previously developed and implemented to provide the object storage as a service. Further, developing and implementing a purely cloud-based object storage service, that is scalable, cost effective, secure, etc., may be time consuming and complicated for developers.

As such, embodiments described herein provide an object storage service (e.g., to expose object storage as a service), where the object storage service is implemented leveraging a percentage of datastore capacity of each datastore of each host cluster that is to participate in the service. For example, three VSAN-based host clusters (e.g., host clusters where local storage resources of hosts belonging to the host cluster are aggregated to create a VSAN) implemented on cloud dedicated infrastructure may be selected (e.g., by a user) for participating in the object storage service. As such, a first percentage of VSAN datastore capacity for the first VSAN-based host cluster, a second percentage of VSAN datastore capacity for the second VSAN-based host cluster, and a third percentage of VSAN datastore capacity for the third VSAN-based host cluster may be leveraged to provide the object storage service to a user and/or cloud-native applications.

To provide the object storage service, objects in each object storage (e.g., in each VSAN) may be grouped into buckets. An object is a file and any metadata that describes that file, while a bucket is a container for objects. A container in this context refers to a data structure used to hold multiple objects. Another example of a container is a folder or directory. An object protocol service may be deployed for each object storage to serve requests for storing and/or retrieving objects from buckets in the corresponding object storage. Using the above example, three object protocol services may be implemented to access objects and buckets created for each VSAN of each VSAN-based host cluster, where one object protocol service is implemented per VSAN. In certain embodiments, the object protocol service(s) are configured to serve Amazon Simple Storage Service (S3) compatible application programming interfaces (APIs) and/or APIs of other object storage services. Amazon S3 is a service made commercially available by Amazon Web Services (AWS), Inc. of Seattle, Washington (e.g., a subsidiary of Amazon.com, Inc. of Bellevue, Washington), that provides object storage through a web service interface. For example, cloud-native application may use the S3 API to communicate with object storage.

Each object protocol service deployed for accessing a particular object storage partaking in the object storage service may be unaware of what objects are stored in the particular object storage for which the object protocol service has access, as well as what other objects are maintained in object storages associated with other object protocol services. As such, as part of the object storage service, an object service proxy may also be deployed. The object service proxy may act as a router for re-directing object requests to their respective object protocol service. The object requests may include requests for creating and/or retrieving objects in each of the object storages associated with the object protocol service. The object service proxy may have a global view of the object storage service being offered including which objects, buckets, and object protocol services are associated with each object storage participating in the object storage service. For example, the object service proxy may maintain information about which objects are stored in which buckets, as well as which buckets belong to which object storages (e.g., for which the object storage service is offered). The object service proxy may also maintain information about which object storage is managed by which object protocol service, and the internet protocol (IP) address associated with each of these object protocol services. The object service proxy may use this information when determining which object protocol service (e.g., managing a particular object storage where an object is to be written and/or retrieved) a request is to be forwarded to such that the request may be processed.

As an illustrative example, a user may generate a request to retrieve a first object stored in a first bucket, where the first object and the first bucket are managed by a first object protocol service. The request may be received by the object service proxy. In response to receiving the request, the object service proxy may determine that the first object protocol service is associated with the object storage containing the first object and the first bucket, and, accordingly, redirect the request to retrieve the first object to the first object protocol service. The first object protocol service may process the request by retrieving the first object such that it may be returned to the user.

Aggregating existing datastore capacity to provide an object storage as a service provides a low cost, low overhead, scalable, and high performance alternative to developing a new object storage service when an SDDC stack is implemented on cloud dedicated infrastructure. In particular, the object storage service described herein provides a low cost solution given users can leverage existing storage space for implementing the service as opposed to paying additional fees for extra storage to implement this service. The object storage service provides decreased operational overhead (and, in turn, increased scalability) given efforts generally required for initial set up and management of an object storage service are reduced. Instead, a user may simply select each datastore, and more specifically, a capacity of each datastore that is to be allocated and aggregated for providing the object storage. The selected capacity of each datastore may be managed as a single pool of storage. Further, the object storage service provides improved performance due to its ability to consume datastore capacity (e.g., VSAN capacity) of multiple datastores in the SDDC (e.g., via the use of the object service proxy), as opposed to the service being constrained per datastore.

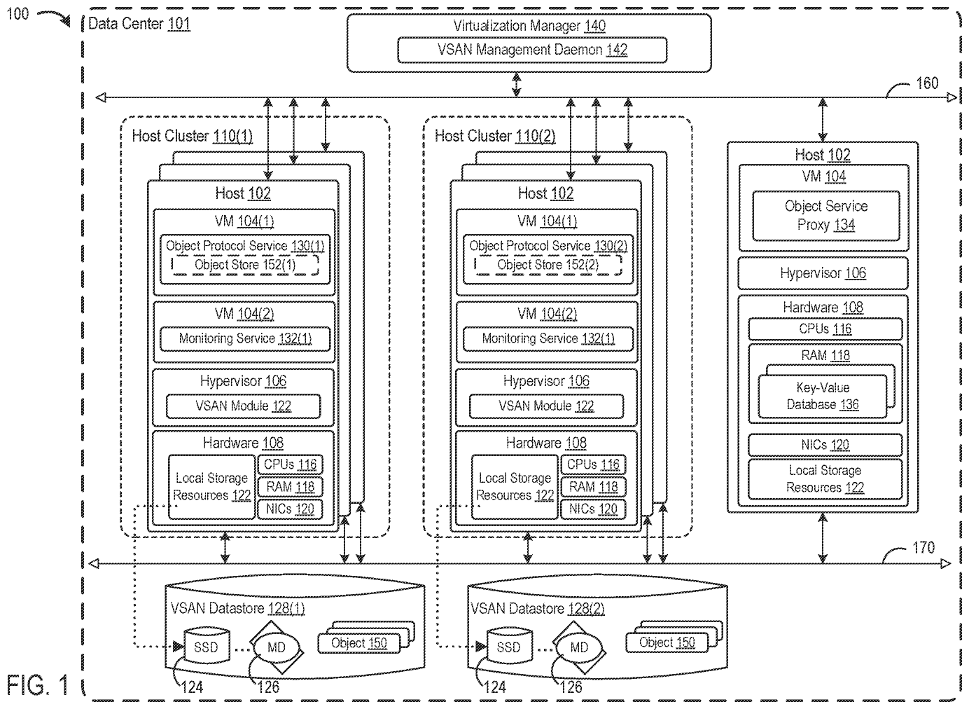

FIG. 1 illustrates example physical and virtual network components in a networking environment 100 in which embodiments of the present disclosure may be implemented.

Networking environment 100 includes a data center 101. Data center 101 includes one or more host clusters 110, each having a plurality of hosts 102, a management network 160, a data network 170, and a virtualization manager 140. Data network 170 and management network 160 may be implemented as separate physical networks or as separate virtual local area networks (VLANs) on the same physical network.

Hosts 102 in data center 101 may be logically grouped into one or more host clusters 110 to provide cluster-level functions to hosts 102 of each host cluster 110, such as VM migration between hosts 102 in the host cluster 110 (e.g., for load balancing), distributed power management, dynamic VM placement according to affinity and anti-affinity rules, high availability, and/or the like. For example, as illustrated in FIG. 1, a first plurality of hosts 102 are logically grouped to form a first host cluster, host cluster 110(1), and a second plurality of hosts 102 are logically grouped to form a second host cluster, host cluster 110(2). Hosts 102 belonging to each host cluster 110 may be geographically co-located servers on the same or different racks in any arbitrary location in the data center 101. Although FIG. 1 illustrates only two host cluster 110 created in data center 101, any number of host clusters 110 may be created for deployed hosts 102 in data center 101.

Host(s) 102 may be communicatively connected to data network 170 and management network 160. Data network 170 and management network 160 are also referred to as physical or “underlay” networks, and may be separate physical networks or the same physical network as discussed. As used herein, the term “underlay” may be synonymous with “physical” and refers to physical components of networking environment 100. As used herein, the term “overlay” may be used synonymously with “logical” and refers to the logical network implemented at least partially within networking environment 100.

Host(s) 102 may be configured to provide a virtualization layer, also referred to as a hypervisor 106, that abstracts processor, memory, storage, and networking resources of a hardware platform 108 into multiple VMs 104. Host(s) 102 may be constructed on a server grade hardware platform 108, such as an x86 architecture platform. Hardware platform 108 of a host 102 may include components of a computing device such as one or more processors (CPUs) 116, system memory (e.g., random access memory (RAM)) 118, one or more network interfaces (e.g., network interface cards (NICs) 120), local storage resources 122, and other components (not shown). A CPU 116 is configured to execute instructions, for example, executable instructions that perform one or more operations described herein and that may be stored in the memory and storage system. The network interface(s) enable host 102 to communicate with other devices via a physical network, such as management network 160 and data network 170.

Local storage resources 122 may be housed in or directly attached (hereinafter, use of the term “housed” or “housed in” may be used to encompass both housed in or otherwise directly attached) to hosts 102. Local storage resources 122 housed in or otherwise directly attached to the hosts 102 may include combinations of solid state drives (SSDs) 124 or non-volatile memory express (NVMe) drives, magnetic disks (MD) 126, or slower/cheaper SSDs, or other types of storages. Local storage resources 122 of hosts 102 belonging to each host cluster 110 may be leveraged to provide an aggregate object-based store to VMs 104 running on hosts 102 in each host cluster 110. The distributed object-based store may be a virtual storage area network (VSAN). For example, local storage resources 122 of the first plurality of hosts 102 in host cluster 110(1) may be aggregated to provide a VSAN datastore 128(1), while local storage resources 122 of the second plurality of hosts 102 in host cluster 110(2) may be aggregated to provide a VSAN datastore 128(2) (VSAN datastore 128(1) and VSAN datastore 128(1) may be individually referred to as “VSAN datastore 128” or “VSAN 128” or collectively referred to as “VSAN datastores 128”).

Additional details of VSAN datastore 128 are described in U.S. Pat. No. 10,509,708, the entire contents of which are incorporated by reference herein for all purposes, and U.S. patent application Ser. No. 17/181,476, the entire contents of which are incorporated by reference herein for all purposes.

Each VSAN datastore 128 is configured to store virtual disks of VMs 104 (e.g., VMs 104 on hosts 102 within the host cluster 110 corresponding to the particular VSAN datastore 128) as data blocks in a number of physical blocks, each physical block having a physical block address (PBA) that indexes the physical block in storage. An object 150 for a specified data block may be created by backing it with physical storage resources of VSAN datastore 128 (e.g., based on a defined policy).

Each host 102 may include a storage management module (referred to herein as a VSAN module 122) in order to automate storage management workflows (e.g., create objects in VSAN datastore 128, etc.) and provide access to objects (e.g., handle I/O operations to objects in VSAN datastore 128, etc.) based on predefined storage policies specified for objects in VSAN datastore 128. VSAN module 122 may use data network 170 to access objects in VSAN datastore 128.

In one embodiment, VSAN module 122 is implemented as a “VSAN” device driver within hypervisor 106 of each host 102. In such an embodiment, VSAN module 122 provides access to a conceptual “VSAN” through which an administrator can create a number of top-level “device” or namespace objects that are backed by VSAN datastore 128.

Although embodiments herein are described with respect to one implementation of VSAN, the techniques are similarly applicable to any distributed storage system. In particular, there exists different deployment options when it comes to VSANs, including deployment options where the storage and compute are not located on the same hardware. For example, a storage-only server/host SAN deployment enables storage to be deployed on hosts 102 in a cluster that are configured to only handle the storage. The cluster then shares that storage, over a network, to compute-only hosts 102. The compute-only hosts may not have VSAN installed directly thereon but may still be able to access the storage. Thus, in such embodiments, no VSAN module 122 may exist on the hosts 102.

In certain embodiments, virtualization manager 140 is a computer program that executes in a server in data center 101, or alternatively, virtualization manager 140 runs in one of VMs 104. Virtualization manager 140 is configured to carry out administrative tasks for the data center, including managing hosts 102, managing (e.g., configuring, starting, stopping, suspending, etc.) VMs 104 running within each host 102, provisioning VMs 104, transferring VMs 104 from one host 102 to another host 102, transferring VMs 104 between data centers, transferring application instances between VMs 104 or between hosts 102, and load balancing VMs 104 among hosts 102 within host cluster 110. Virtualization manager 140 takes commands as to creation, migration, and deletion decisions of VMs 104 and application instances on the data center 101. However, virtualization manager 140 also makes independent decisions on management of local VMs 104 and application instances, such as placement of VMs 104 and application instances between hosts 102.

According to embodiments described herein, an object storage service is implemented in data center 101 by (1) creating an object store 152 per VSAN datastore 128, where each created object store 152 is aggregated to provide a single object storage, (2) deploying an object protocol service 130 per host cluster 110, and (3) deploying an object service proxy 134 in data center 101. In certain aspects, an object store is an aggregate of storage space of one or more physical storage devices, such as a portion of each of one or more physical storage devices. The object store may be managed as though it were a single storage device. The one or more physical storage devices may be storage devices of a VSAN datastore, as discussed herein. As described above, the object storage service exposes use of the VSAN storage in data center 101 as a service such that a user may make a request to the object storage service, to read and/or write data, without needing to understand the underlying file system structure, including where and/or how data is stored and/or managed.

As illustrated in FIG. 1, an object protocol service 130 is deployed per host cluster 110. The object protocol service 130 is configured to serve requests for objects stored in (e.g., to read and/or write objects to) a VSAN datastore 128 created for hosts 102 in the host cluster 110 where the object protocol service 130 is deployed. Objects 150 in VSAN datastore 128 may be grouped into one or more buckets (and/or other containers) to create an object store 152 that is managed by object protocol service 130. Object protocol service 130 may be configured to retrieve objects 150 from object store 152, as well as write objects 150 to object store 152. In certain embodiments, object protocol service 130 is configured to perform such operations based on object requests received from an object service proxy 134. In certain embodiments, object protocol service 130 is deployed in a VM 104 running on one of the hosts 102 of host cluster 110. In certain embodiments, object protocol service 130 is deployed directly on host 102 and/or in another virtual commuting instance (VCI).

In certain embodiments, failover mechanisms are provided to failover an object protocol service 130 to another VM 104 and/or host 102 in the host cluster where the object protocol service 130 is deployed. In particular, a monitoring service 132 may be implemented on a host 102 in each host cluster 110 (e.g., such that monitoring service 132 is a cluster-level service). Monitoring service 132 may be configured to monitor the state of an object protocol service 130 deployed in the same host cluster 110. Monitoring service 132 may determine the state of the object protocol service 130 by periodically pinging the object protocol service 130 to request a response from the object protocol service. If in response to a ping request the object protocol service 130 fails to reply, monitoring service 132 may determine that object protocol service 130 has failed and take action to failover this object protocol service 130 to another VM 104 and/or host 102 in the host cluster 110. For example, monitoring service 132 may request another host 102 in host cluster 110 to restart the object protocol service 130 on the host 102, and host 102 may restart object protocol service 130 in response to receiving the request. As such, the object storage service for this particular host cluster 110 (e.g., more specifically, its VSAN datastore 128) may be continuously provided thereby increasing overall performance of the service.

Object service proxy 134 deployed for the object storage service may be configured to redirect object requests to object protocol services 130 which have access to the requested objects 150 and/or buckets where objects 150 are to be written. Object service proxy 134 may be configured to redirect such requests to object protocol services 130 using an IP address assigned to each of the object protocol services 130. Object service proxy 134 may maintain a global view of all objects 150, buckets, and object stores 152 provided for the object storage service. In other words, object service proxy 134 may have knowledge of which bucket each object 150 is stored in, and in some cases, knowledge of which object store 152 each bucket is created for. Further, object service proxy 134 may maintain mappings of object protocol services 130 and the object stores 152 they provide access to (e.g., knowledge that object protocol service 130(1) is deployed in host cluster 110(1) and is configured to access objects 150 in object store 152(1)).

Though object service proxy 134 is illustrated as running in a VM 104 on an independent host 102 not within host cluster 110(1) or host cluster 110(2), in certain embodiments, the VM 104 hosting object service proxy 134 is running on a host 102 within any host cluster 110 in data center 101 (e.g., such as host cluster 110(1) or host cluster 110(2)). For example, object service proxy 134 may be running in virtualization manager 140, or in a VM running on the same host as virtualization manager 140.

In certain embodiments, object service proxy 134 maintains this information in key-value databases 136. Key-value databases 136 are key-value data structures that, when given a key, return a value that is mapped to that key. The key-value mappings are mappings from the key to the value.

A first key-value database 136 maintained by object service proxy 134 includes first key-value mappings, each mapping being between (a) the key, which is an identifier of an object (e.g., “Object 123”), and (b) the value, which is an identifier of a bucket where the object 150 is stored. Buckets of different object stores 152 may have unique identifiers. In some cases, the value further includes an identifier of an object store 152 where the object 150 is stored and/or an identifier of a host cluster 110 containing the object store 152 where the object 150 is stored.

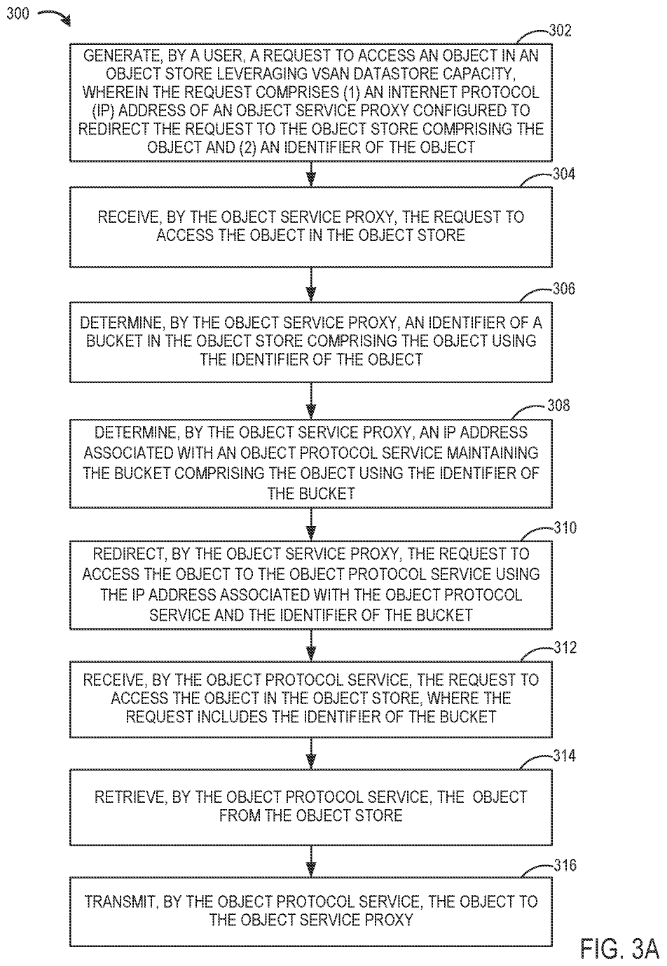

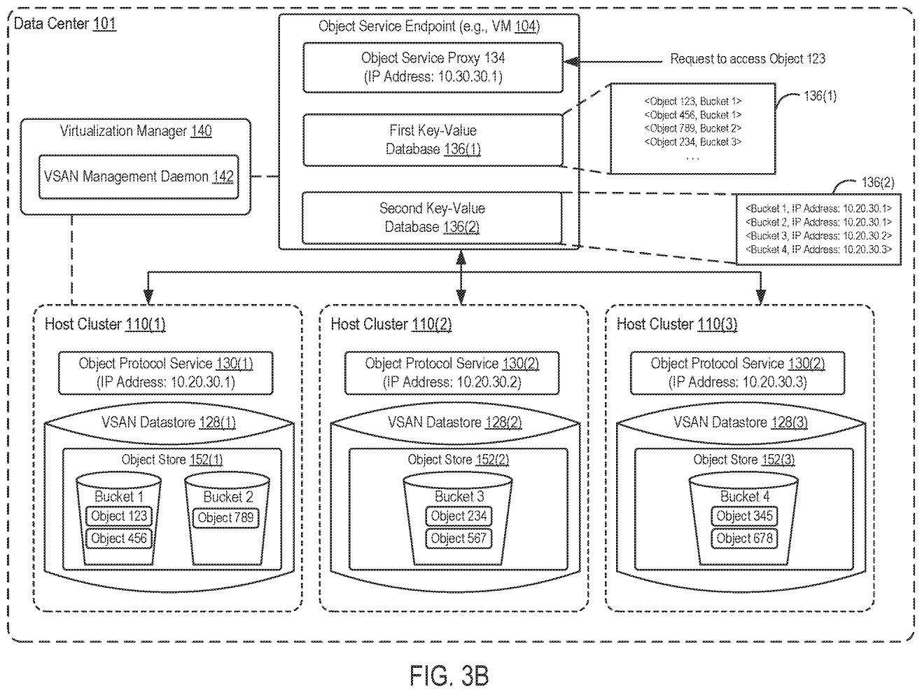

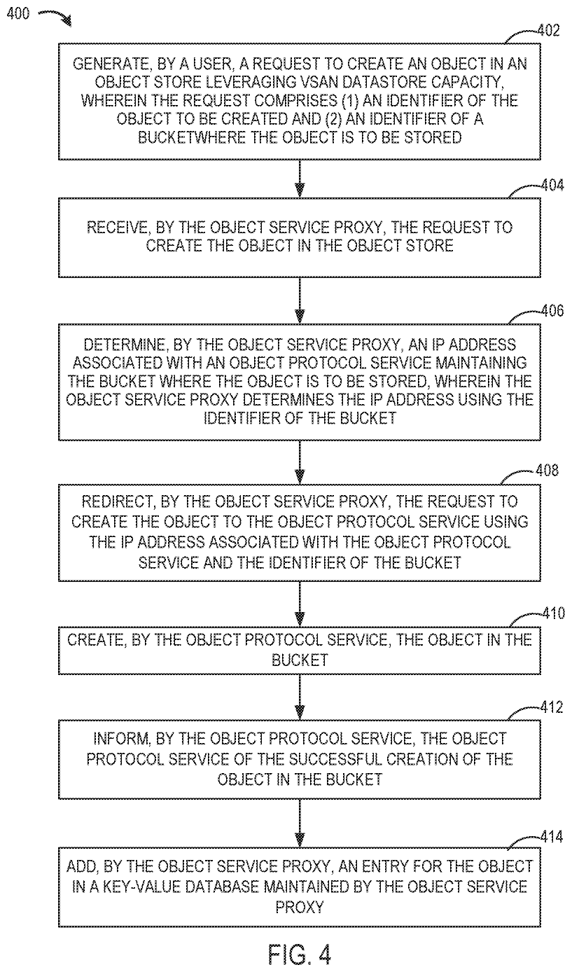

A second key-value database 136 maintained by object service proxy 134 includes second key-value mappings, each mapping being between (a) the key, which is an identifier of a bucket (e.g., “Bucket 1”) where an object 150 is stored, and (b) the value, which is an IP address of an object protocol service 130 which has access to the bucket where the object 150 is stored. In some cases, the value further includes an identifier of an object store 152 where the object 150 is stored and/or an identifier of a host cluster 110 containing the object store 152 where the object 150 is stored. Additional details regarding key-value databases 136 are provided below with respect to FIGS. 3A, 3B, and 4.

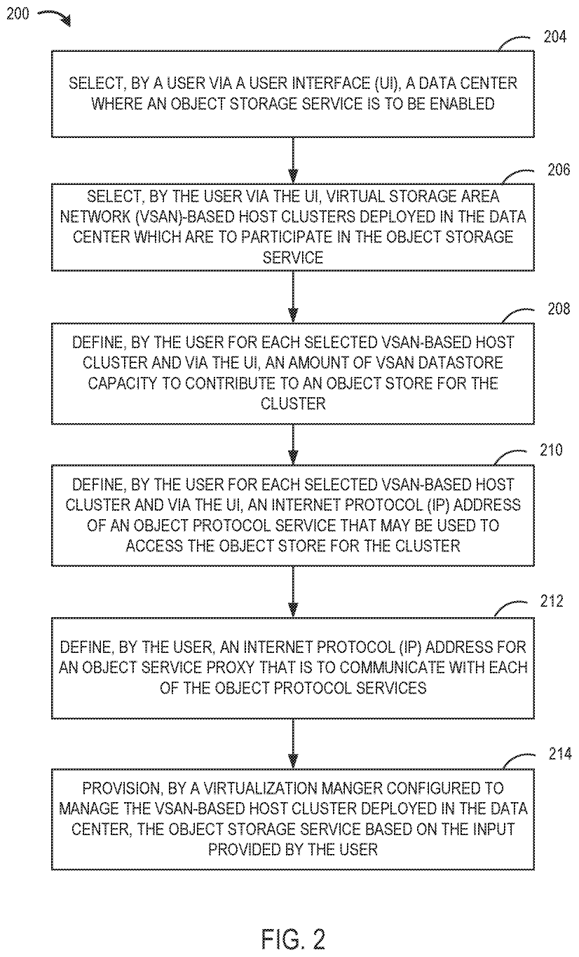

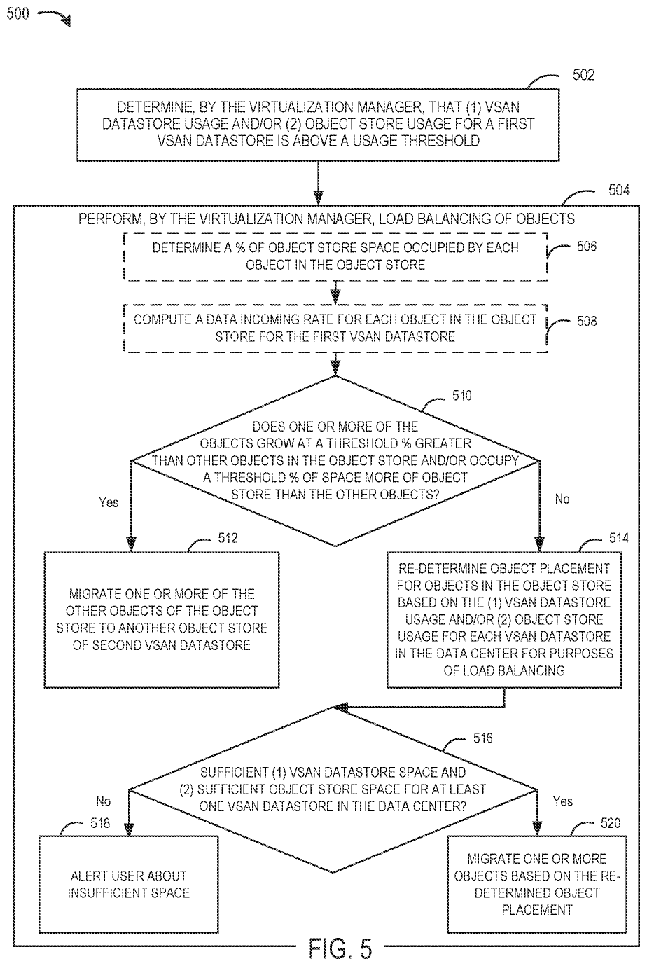

In certain embodiments, a VSAN management daemon 142 may be running in virtualization manager 140. VSAN management daemon 142 may be configured to provision and monitor the health of object service proxy 134 deployed for the object storage service. Further, VSAN management daemon 142 may be configured for provisioning and lifecycle management of object stores 152 and object protocol services 130 deployed across host cluster 110 for the object storage service. Details regarding provisioning object stores 152, deploying object protocol services 130, and deploying object service proxy 134 are described in detail with respect to FIG. 2. VSAN management daemon 142 may also be configured to perform load balancing of objects 150 across object stores 152. Details regarding such load balancing are described in detail with respect to FIG. 5.

FIG. 2 is a flow diagram illustrating example operations 200 for provisioning an object storage service for VSAN-based host clusters 110 in data center 101, according to an example embodiment of the present disclosure. Operations 200 may be performed by virtualization manager 140, and more specifically, VSAN management daemon 142, illustrated in FIG. 1. For purposes of explanation, and not meant to be limiting to this particular example, operations 200 may be performed to provision an object storage service for objects 150 in VSAN datastore 128(1), associated with host cluster 110(1), and objects 150 in VSAN datastore 128(2), associated with host cluster 110(2). In certain other embodiments, a fewer or greater number of VSAN datastores 128 may be selected for participating in the object storage service.

Operations 200 begin, at operation 204, by a user selecting a data center 101 where an object storage service is to be enabled. The data center 101 may be a data center provisioned on cloud dedicated infrastructure. As described above, for this example, the selected data center may be data center 101 illustrated in FIG. 1.

At operation 206, the user selects VSAN-based host cluster 110 deployed in data center 101 which are to participate in the object storage service. For this example, the user selects VSAN-based host cluster 110(1) and VSAN-based host cluster 110(2).

The user may select data center 101, and the VSAN datastores 128 of data center 101, at operations 204 and 206, respectively, via a user interface (UI).

At operation 208, the user defines an amount of VSAN datastore 128 capacity to contribute to an object store for each selected VSAN-based host cluster 110. In certain embodiments, the user defines the amount of VSAN datastore 128 capacity to allocate to the object store as a percentage of overall VSAN datastore 128 capacity (e.g., 10%). In certain embodiments, the amount of VSAN datastore 128 capacity selected may be an amount of spare VSAN datastore 128 capacity available. For example, VSAN datastore may use only 75-80% of the capacity allocated to the VSAN datastore 128. Thus, 20-25% of VSAN datastore 128 (e.g., spare space of VSAN datastore 128) may be selected by the user to contribute to the object store. The amount of VSAN datastore 128 spare space may vary across VSAN datastores 128 selected to participate in the object storage service (e.g., selected at operation 206).

At operation 210, the user defines an IP address that may be assigned to an object protocol service 130 that is to be deployed for accessing each of the VSAN datastores 128 for which the object storage service is implemented. For example, the user may define and assign IP address “10.20.30.1” to a first object protocol service 130(1) that is to be deployed for accessing objects 150 in VSAN datastore 128(1). Further, the user may define and assign IP address “10.20.30.3” to a second object protocol service 130(2) that is to be deployed for accessing objects 150 in VSAN datastore 128(2).

At operation 212, the user defines an IP address that may be assigned to an object service proxy 134 that is to be deployed for communicating with each object protocol service 130. For example, the user may define and assign an IP address “10.30.30.1” to an object service proxy 134 that is to be deployed and configured for communicating with first object protocol service 130(1) and second object protocol service 130(2). As described below, IP address assigned to object service proxy 134 is an external IP address that may be used by users when utilizing the object storage service. In certain other aspects, an IP address may be automatically assigned.

As described below, in certain aspects, the IP address assigned to object service proxy 134 is an external IP address (e.g., externally addressable outside of data center 101) used, by users, when utilizing the object storage service (e.g., to write and/or retrieve data). On the other hand, in certain aspects, IP addresses assigned to object protocol services 130 may be used to by object service proxy 134 to redirect requests to create and/or retrieve objects in object stores managed by the object protocol services 130. As such, in certain aspects, the IP address assigned to object service proxy 134 is an external IP address, while IP addresses assigned to object protocol services 130 are internal IP addresses (e.g., only internally addressable within data center 101).

The user may define the amount of VSAN datastore 128 capacity, the IP address(es) to assign to the object protocol service(s) 130, and the IP address to assign to the object service proxy 134 at operations 208, 210, and 212, respectively, via a UI.

At operation 214, virtualization manager 140, and more specifically, VSAN management daemon 142, provisions the object storage service in the selected data center 101. VSAN management daemon 142 may provision the object storage service based on the input provided by the user at operations 204-210. For this example, provisioning the object storage service involves creating an object store 152(1) for host cluster 110(1) and an object store 152(2) for host cluster 110(2) (e.g., where objects 150 in VSAN datastore 128(1) and VSAN datastore 128(2), respectively, are organized into buckets). Further, a first object protocol service 130(1) is deployed on a single host 102 in host cluster 110(1), a second object protocol service 130(2) is deployed on a single host 102 in host cluster 110(2), and an object service proxy 134 is deployed on any suitable host 102 in data center 101. Lastly, two key-value databases 136 are provisioned for management by object service proxy 134. The first key-value database 136 may contain first key-value mappings, where each mapping is between (1) a key, which is an identifier of an object 150 in object store 152(1) or object store 152(2), and (b) the value, which is an identifier of a bucket where the object 150 is stored. The second key-value database 136 may contain second key-value mappings, where each mapping is between (1) a key, which is an which is an identifier of a bucket where an object 150 is stored, and (b) the value, which is an IP address of object protocol service 130(1) or object protocol service 130(2), based on where the object 150 is stored.

Subsequent to implementing the object storage service for data center 101, a user may issue requests to retrieve objects 150 of object store 152(1) (e.g., stored in VSAN datastore 128(1)) and/or objects 150 of object store 152(2) (e.g., stored in VSAN datastore 128(2)). Further, a user may issues requests to create objects 150 in object store 152(1) and/or object store 152(2). In some cases, the user may specify particular buckets where the objects 150 are to be created and stored.

FIG. 3A is a flow diagram illustrating example operations 300 for accessing and retrieving objects 150 in object stores 152 via the object storage service, according to an example embodiment of the present disclosure. Operations 300 may be performed by object service proxy 134 and object protocol services 130 illustrated in FIG. 1. For ease of explanation, and not meant to be limiting to this particular example, operations 300 may be described with respect to the example illustrated in FIG. 3B. In particular, FIG. 3B illustrates an example architecture for accessing an object 150 (e.g., “Object 123”) belonging to an object store 152(1) created leveraging capacity of VSAN datastore 128(1), according to an example embodiment of the present disclosure.

Operations 300 begin, at operation 302, by a user generating a request to access an object 150 in an object store 152 leveraging VSAN datastore 128 capacity. For this example, as illustrated in FIG. 3B, the request may be a request to access object 123 of object store 152(1) (e.g., stored in VSAN datastore 128(1)). The request may include an identifier of the object being requested (e.g., “Object 123”). Further, the request may include an IP address of object service proxy 134 illustrated in FIG. 3B (e.g., IP Address 10.30.30.1), such that object service proxy 134 receives the request. As described above, object service proxy 134 may be configured to redirect the request, when received, to an object protocol service 130 which has access to the requested object.

At operation 304, object service proxy 134 receives the request to access object 123. In response to receiving the request, at operation 306, object service proxy 134 determines an identifier of a bucket comprising object 123. Object service proxy 134 makes this determination using an identifier of the object 150 (e.g., “Object 123”) as a key to search first key-value database 136 having first key-value mappings of <Object ID, Bucket ID>.

Further, at operation 308, object service proxy 134 determines an IP address associated with an object protocol service 130 maintaining the bucket where object 123 is stored. Object service proxy 134 makes this determination using the identifier of the bucket (e.g., determined at operation 306) as a key to search second key-value database 136 having second key-value mappings of <Bucket ID, IP Address of Object Protocol Service 130>.

For example, as shown in FIG. 3B, a first key-value database 136(1) contains a plurality of first key-value mappings, where a key of each of the first key-value mappings is an object identifier associated with an object 150 belonging to object store 152(1). The value of each of the first key-value mappings in the first key-value database 136(1) is an identifier of a bucket where the corresponding object 150 is stored. A second key-value database 136(2) contains a plurality of second key-value mappings, where a key of each of the second key-value mappings is an identifier of a bucket where objects 150 are stored. The value of each of the second key-value mappings in the second key-value database 136(2) is an IP address of an object protocol service 130 configured to access the corresponding bucket.

For the example provided in FIG. 3B, the first key-value database 136(1) includes seven first key-value mappings (although only four first key-value mappings are illustrated), where each mapping corresponds to one object 150 stored in object store 152(1), object store 152(2), or object 152(3). The second key-value database 136(2) includes four second key-value mappings, where each mapping corresponds to one bucket stored in object store 152(1), object store 152(2), or object 152(3).

After receiving a request to access an object 150 associated with object identifier “Object 123,” object service proxy 134 may use first key-value database 136 to determine that Object 123 is stored in bucket 1 (e.g., which is in object store 152(1)). Further, object service proxy 134 may use second key-value database 136 to determine that the request to access Object 123 is to be redirected to IP address 10.20.30.1 (e.g., an IP address of object protocol service 130(1)) based on the mapping of <Bucket 1, IP Address 10.20.30.1>.

Accordingly, at operation 310, object service proxy 134 redirects the received request to access Object 123 to object protocol service 130(1) using IP address 10.20.30.1 (e.g., IP address associated with object protocol service 130(1)). Object service proxy 134 may also provide object protocol service 130(1) with information that Object 123 is stored in bucket 1.

At operations 312 and 314, respectively, object protocol service 130(1) receives the redirected request (including the indication of Bucket 1) and retrieves Object 123 from bucket 1. At operation 316, object protocol service 130(1) transmits Object 123 to object service proxy 134 such that object service proxy 134 may provide the Object 123 to the user.

FIG. 4 is a flow diagram illustrating example operations 400 for creating an object 150 in an object store 152 via the object storage service, according to an example embodiment of the present disclosure. Operations 400 may be performed by an object service proxy 134 and object protocol service(s) 130 illustrated in FIG. 1.

Operations 400 begin, at operation 402, by a user generating a request to create an object in an object store 152 leveraging VSAN datastore 128 capacity. For example, a user may generate a request to create a new object 150 corresponding to identifier “Object 879” in bucket 4 (e.g., part of object store 152(3) of VSAN datastore 128(3)) illustrated in FIG. 3B. The request may include an identifier of object 150 to be created, or in other words, contain an indication that the object is “Object 879.” Further, the request may include an identifier of a bucket, such as bucket 4, without specifying the object store 152 where the bucket is located, where Object 879 is to be created. In particular, a user may have a bucket level view of available buckets in object stores 152(1), 162(2), and 152(3) which make up the object protocol service.

Further, in certain embodiments, instead of a user specifying the bucket where the object 150 is to be created, object service proxy 134 may determine which bucket is to store the object 150. In particular, object service proxy 134 may efficiently distribute objects 150 across buckets (and/or object stores 152) to help balance the load across each of the buckets (and/or object stores 152). As such, the request to create the object 150, generated by the user at operation 402, may include only an identifier of the object 150 to be created. Object service proxy 134 may determine a bucket and/or object store 152 for storing the Object based on an amount of available capacity of the total capacity allocated to each object store 152 and a size of the object to be stored (e.g., included in the header of the request from the user).

At operation 404, object service proxy 134 receives the request to create Object 879 in bucket 4. In response to receiving the request, at operation 406, object service proxy 134 determines an IP address associated with an object protocol service 130 maintaining bucket 4 (e.g., the bucket where Object 879 is to be written and stored). Object service proxy 134 may make this determination using an identifier of bucket 4 (e.g., indicated in the request) and second key-value database 136(2). For this example, object service proxy 134 may use second key-value database 136(2) to determine that the request to create Object 879 in bucket 4 is to be redirected to IP address 10.20.30.3 (e.g., an IP address of object protocol service 130(3) which maintains bucket 4).

Accordingly, at operation 408, object service proxy 134 redirects the received request to create Object 879 to object protocol service 130(3) using IP address 10.20.30.3 (e.g., IP address associated with object protocol service 130(3)). Object service proxy 134 may also provide object protocol service 130(3) with information that Object 879 is to be stored in bucket 4.

In response to receiving the request, at operation 410, object protocol service 130(3) creates Object 879 in bucket 4 for object store 152(3). At operation 412, object protocol service 130(2) informs object service proxy 134 of the successful creation of Object 870 in bucket 4. At operation 414, in response to being informed at operation 412, object service proxy 134 adds an entry for Object 879 in key-value database 136 maintained by object service proxy 134. For example, object service proxy 134 may add entry <Object 879, Bucket 4> to first key-value database 136 illustrated in FIG. 3B.

As described above, in certain embodiments, VSAN management daemon 142, running in virtualization manager 140, may be configured to perform load balancing across object stores 152. More specifically, VSAN management daemon 142 may be configured to monitor capacity usage by object store 152 for each VSAN datastore 128 and/or overall capacity usage of VSAN datastore 128(including object store 152) and trigger rebalancing of objects 150 across object stores 152 when capacity usage is above a threshold. In certain embodiments, the threshold is set based on a policy defined by a user. In certain embodiments, the threshold may be a percentage of VSAN datastore 128 allocated to object store 152. For example, if an object store 152 is allocated 10% of a VSAN datastore 128, when VSAN datastore 128 capacity is reduced, for example, due to one or more host 102 failures, the 10% capacity allocated for the object store 152 may be reduced given total capacity of VSAN datastore 128 is reduced (e.g., 10% of VSAN datastore 128 with larger capacity>10% of VSAN datastore 128 with smaller capacity). When an amount of capacity allocated to object store 152 is reduced, the capacity being used (e.g., when the one or more hosts 102 fail) may be above the 10% threshold. As such, VSAN management daemon 142 may trigger rebalancing of objects 150 across object stores 152. In certain embodiments, the threshold may be a percentage of overall VSAN datastore 128 capacity, including capacity allocated to object store 152. For example, a user may set a threshold equal to 85% of VSAN datastore capacity; thus, when VSAN datastore 128(include object store 152) capacity reaches 90%, for example, VSAN management daemon 142 may trigger rebalancing of objects 150 across object stores 152.

FIG. 5 is a workflow illustrating example operations 500 for load balancing of objects 150 across object stores 152 in a data center 101, according to an example embodiment of the present disclosure. Although not meant to be limiting to this particular example, operations 500 may be described with respect to the load balancing of objects 150 across object store 152(1) and object store 152(2) illustrated in FIG. 1.

Operations 500 begin, at operation 502, by VSAN management daemon 142 determining that (1) VSAN datastore 128 usage and/or (2) object store 152 usage for a first VSAN datastore 128 is above a usage threshold. For this example, it may be assumed that, at operation 502, VSAN management daemon 142 determines that object store 152(1) usage is above a threshold usage. In particular, a user may have previously allocated 10% of VSAN datastore 128(1) to object store 152(2), and current object store 152(1) usage is at 15% of VSAN datastore 128(1).

As such, at operation 504, VSAN management daemon 142 performs load balancing. Load balancing operations 504 performed by VSAN management daemon 142 may include operations 506-520. Load balancing operations 504 may be performed to migrate one or more objects 150 from object store 152(1) (e.g., object store with above threshold usage) to object store 152(2) (e.g., object store with below threshold usage).

In certain embodiments to determine which object(s) to migrate to another object store 152 (e.g., object store 152(2)), VSAN management daemon 142 determines, at operation 506, a percentage of object store 152 space occupied by each object 150 in object store 152. For this example, VSAN datastore 128(1) may have a capacity of 100 terabytes (TB). A user may have previously specified that object store 152(1) is to be allocated 10% of VSAN datastore 128 (e.g., 10%*100 TB=10 TB). Object store 152(1) may include 50 million objects 150. As such, at operation 506, VSAN management daemon 142 may determine what percentage of object store 152(1) (e.g., percentage of the 10 TB allocated to object store 152(1)) each of the 50 million objects 150 occupies.

In certain embodiments (alternative to or in addition to operation 506), at operation 508, VSAN management daemon 142 computes a data incoming rate for each object 150 in object store 152(1). A data incoming rate represents a rate at which new data for an object 150 in object store 152(1) is provided causing growth of the object 150. For example, in object store 152(1) a first object 150, Object 123, may be created. At a later time, more data may be added to Object 123 by deleting the previous Object 123 and creating a new Object 123 in object store 152(1). In certain embodiments, VSAN management daemon 142 may monitor data incoming rate for Object 123, as well as other objects 150 in object store 152(1). VSAN management daemon 142 may monitor for this data incoming rate information by reading object information, such as object size, for the object 150 stored in a bucket at different times and calculating a rate of change. In certain embodiments, VSAN management daemon 142 may receive object size information about each object from object service proxy 134 (e.g., obtained by object service proxy 134 from the headers of object requests from users, as described above), and calculate the data incoming rate for objects based on this information.

At operation 510, VSAN management daemon 142 determines whether one or more of the objects 150 in object store 152(1) (1) grow at a threshold percentage greater than other objects 150 in object store 152(1) and/or (2) occupy a threshold percentage of space more of object store 152(1) than other objects 150. For this example, VSAN management daemon may determine that Object 123 grows at a 10% faster rate than other objects 150 in object store 152(1) and Object 123 occupies a 20% greater amount of storage than most other objects 150 in object storage 152(1).

In cases where, at operation 510, VSAN management daemon 142 determines that one or more of the objects 150 in object store 152(1) (1) grow at the threshold percentage greater than other objects 150 in object store 152(1) and/or (2) occupy the threshold percentage of space more of object store 152(1) than other objects 150, at operation 512, VSAN management daemon 142 determines to migrate such objects 150 in object store 152(1) to another object store 152, such as object store 152(2). For the provided example, VSAN management daemon 142 may determine to migrate Object 123 to object store 152(2).

Alternatively, where, at operation 510, VSAN management daemon 142 determines that one or more of the objects 150 in object store 152(1) (1) do not grow at the threshold percentage greater than other objects 150 in object store 152(1) and/or (2) do not occupy the threshold percentage of space more of object store 152(1) than other objects 150, at operation 514, VSAN management daemon 142 re-determines object placement for objects 150 in object store 152(2) for purposes of load balancing the objects 150 across available object stores 152/VSAN datastores 128.

VSAN management daemon 142 makes this re-determination based on (1) overall VSAN datastore 128 usage of each VSAN datastore 128 participating in the object storage service and/or (2) object store 152 usage for each VSAN datastore 128 in data center 101. As an illustrative example, three VSAN datastores 128 may be participating in the object storage service, such as VSAN datastore 128(1), VSAN datastore 128(2), and VSAN datastore 128(3) illustrated in FIG. 3B. Ten percent (10%) of VSAN datastore 128(1) capacity may be allocated to object store 152(1), ten percent (10%) of VSAN datastore 128(2) capacity may be allocated to object store 152(2), and twenty (20%) of VSAN datastore 128(3) capacity may be allocated to object store 152(3). Object store 152(1) may include multiple objects including the three objects illustrated in FIG. 3B. These multiple objects may utilize over the ten percent capacity of VSAN datastore 128(1) that is allocated to object store 152(1). As such, VSAN management daemon 142 may determine that object store 152(1) usage is above a usage threshold and further perform load balancing to reduce the usage below the threshold. In other words, VSAN management daemon 142 may determine a number of objects, and specifically which objects in object store 152(1), are to be moved to one or more of the other object stores 152 (e.g., object store 152(2) and/or object store 152(3)) for purposes of load balancing. VSAN management daemon 142 may take into consideration how much of the ten percent capacity of VSAN datastore 128(2), allocated to object store 152(2), is being used by objects in object store 152(2), as well as how much of the twenty percent capacity of VSAN datastore 128(3), allocated to object store 152(3), is being used by objects in object store 152(3) in determining which object store 152 objects of object store 152(1) should be migrated to.

At operation 516, VSAN management daemon 142 determines whether there is sufficient VSAN datastore 128 space and/or sufficient object store 152 for one or more of the objects stores 152/VSAN datastores 128 participating in the object store service. Where, at operation 516, VSAN management daemon 142 determines that there is not sufficient capacity for migrating objects 150 (e.g., a threshold amount of VSAN datastore 128 capacity and/or a threshold amount of object store 152 capacity for each VSAN datastore 128 is already being used), at operation 518, virtualization manager 140 may alert a user about insufficient space for the object storage service. Virtualization manager 140 may alert a user via a UI. Alternatively, at operation 520, where there is sufficient space, VSAN management daemon 142 migrates one or more objects 150 to one or more object stores 152 of VSAN datastores 128 participating in the object storage service such that objects 150 are balanced across the object stores 152. In this context, balanced may not necessarily refer to each object store 152 having a same number of objects 150. Instead, balanced may refer to each object store and/or VSAN datastore 128 using a similar percentage of VSAN datastore 128 capacity and/or object store 152 capacity that is allocated for the object storage service (e.g., 60% of allocated object store 152(1) capacity is being used while 55% of allocated object store 152(2) capacity is being used).

The various embodiments described herein may employ various computer-implemented operations involving data stored in computer systems. For example, these operations may require physical manipulation of physical quantities usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method for exposing object storage as a service, the method comprising:
receiving, by an object service proxy provisioned for providing the service, a request to access a first object in an object store, wherein the object store leverages a percentage of datastore capacity for a datastore;
determining, by the object service proxy, both of:
an identifier of a first container in the object store comprising the first object; and
an internet protocol (IP) address associated with an object protocol service provisioned to access the first container comprising the first object;
re-directing, by the object service proxy, the request to access the first object to the object protocol service using the IP address associated with the object protocol service, wherein the request comprises the identifier of the first container; and
in response to re-directing the request to the object service proxy, receiving the first object from the object protocol service.

2. The method of claim 1, wherein determining the identifier of the first container comprising the first object is performed by the object service proxy using an identifier of the first object as a first key to search a first key-value database to determine the identifier of the first container, the first key-value database comprising:
a plurality of first key-value mappings between a first plurality of keys and a first plurality of values,
the first plurality of keys each being a corresponding identifier of corresponding object, the first plurality of keys including the first key, and
the first plurality of values each being a corresponding identifier of a corresponding container where the corresponding object is stored, the first plurality of values including a first value that is the identifier of the first container.

3. The method of claim 2, wherein determining the IP address associated with the object protocol service provisioned to access the first container comprising the first object is performed by the object service proxy using the identifier of the first container as a second key to search a second key-value database to determine the IP address associated with the object protocol service, the second key-value database comprising:
a plurality of second key-value mappings between a second plurality of keys and a second plurality of values,
the second plurality of keys each being the corresponding identifier of the corresponding container where the corresponding object is stored, the second plurality of keys including the second key, and
the second plurality of values each being a corresponding IP address associated with a corresponding object protocol service provisioned to access the corresponding container, the second plurality of values including a second value that is the IP address associated with the object protocol service.

4. The method of claim 1, further comprising:
receiving by the object service proxy, another request to create a second object;
determining, by the object service proxy, to create the second object in the first container in the object store;
determining, by the object service proxy, the IP address associated with the object protocol service provisioned to access the first container;
re-directing, by the object service proxy, the request to create the second object to the object protocol service using the IP address associated with the object protocol service; and
in response to re-directing the request to the object service proxy, receiving, by the object service proxy from the object protocol service, an indication that the second object has been created.

5. The method of claim 4, wherein the object service proxy determines to create the second object in the first container in the object store based on:
an identifier of the first container included in the other request; or
a current usage of the percentage of the datastore capacity allocated to the object store.

6. The method of claim 1, wherein the percentage of the datastore capacity leveraged by the object store is limited to a threshold amount.

7. The method of claim 6, wherein:
a plurality of object stores, including the object store, are aggregated to provide the service, wherein each of the plurality of object stores leverages a percentage of capacity of different datastores; and
the method further comprises:
determining, by a virtualization manager configured to monitor usage of the datastore capacity by the object store, that the object store is using an amount of the datastore capacity greater than the threshold amount; and
performing, by the virtualization manager, load balancing of objects in the plurality of object stores to reduce the usage of the datastore capacity by the object store below the threshold amount.

8. A system comprising:
one or more processors; and
at least one memory, the one or more processors and the at least one memory configured to:
receive, by an object service proxy provisioned for providing the service, a request to access a first object in an object store, wherein the object store leverages a percentage of datastore capacity for a datastore;
determine, by the object service proxy, both of:
an identifier of a first container in the object store comprising the first object; and
an internet protocol (IP) address associated with an object protocol service provisioned to access the first container comprising the first object;
re-direct, by the object service proxy, the request to access the first object to the object protocol service using the IP address associated with the object protocol service, wherein the request comprises the identifier of the first container; and
in response to re-directing the request to the object service proxy, receive the first object from the object protocol service.

9. The system of claim 8, wherein object service proxy determines the identifier of the first container comprising the first object using an identifier of the first object as a first key to search a first key-value database to determine the identifier of the first container, the first key-value database comprising:
a plurality of first key-value mappings between a first plurality of keys and a first plurality of values,
the first plurality of keys each being a corresponding identifier of corresponding object, the first plurality of keys including the first key, and
the first plurality of values each being a corresponding identifier of a corresponding container where the corresponding object is stored, the first plurality of values including a first value that is the identifier of the first container.

10. The system of claim 9, wherein the object service proxy determines the IP address associated with the object protocol service provisioned to access the first container comprising the first object using the identifier of the first container as a second key to search a second key-value database to determine the IP address associated with the object protocol service, the second key-value database comprising:
a plurality of second key-value mappings between a second plurality of keys and a second plurality of values,
the second plurality of keys each being the corresponding identifier of the corresponding container where the corresponding object is stored, the second plurality of keys including the second key, and
the second plurality of values each being a corresponding IP address associated with a corresponding object protocol service provisioned to access the corresponding container, the second plurality of values including a second value that is the IP address associated with the object protocol service.

11. The system of claim 8, wherein the one or more processors and the at least one memory are further configured to:
receive by the object service proxy, another request to create a second object;
determine, by the object service proxy, to create the second object in the first container in the object store;
determine, by the object service proxy, the IP address associated with the object protocol service provisioned to access the first container;
re-direct, by the object service proxy, the request to create the second object to the object protocol service using the IP address associated with the object protocol service; and
in response to re-directing the request to the object service proxy, receive, by the object service proxy from the object protocol service, an indication that the second object has been created.

12. The system of claim 11, wherein the object service proxy determines to create the second object in the first container in the object store based on:
an identifier of the first container included in the other request; or
a current usage of the percentage of the datastore capacity allocated to the object store.

13. The system of claim 8, wherein the percentage of the datastore capacity leveraged by the object store is limited to a threshold amount.

14. The system of claim 13, wherein:
a plurality of object stores, including the object store, are aggregated to provide the service, wherein each of the plurality of object stores leverages a percentage of capacity of different datastores; and
the one or more processors and the at least one memory are further configured to:
determine, by a virtualization manager configured to monitor usage of the datastore capacity by the object store, that the object store is using an amount of the datastore capacity greater than the threshold amount; and
perform, by the virtualization manager, load balancing of objects in the plurality of object stores to reduce the usage of the datastore capacity by the object store below the threshold amount.

15. A non-transitory computer-readable medium comprising instructions that, when executed by one or more processors of a computing system, cause the computing system to perform operations for exposing object storage as a service, the operations comprising:
receiving, by an object service proxy provisioned for providing the service, a request to access a first object in an object store, wherein the object store leverages a percentage of datastore capacity for a datastore;
determining, by the object service proxy, both of:
an identifier of a first container in the object store comprising the first object; and
an internet protocol (IP) address associated with an object protocol service provisioned to access the first container comprising the first object;
re-directing, by the object service proxy, the request to access the first object to the object protocol service using the IP address associated with the object protocol service, wherein the request comprises the identifier of the first container; and
in response to re-directing the request to the object service proxy, receiving the first object from the object protocol service.

16. The non-transitory computer-readable medium of claim 15, wherein determining the identifier of the first container comprising the first object is performed by the object service proxy using an identifier of the first object as a first key to search a first key-value database to determine the identifier of the first container, the first key-value database comprising:
a plurality of first key-value mappings between a first plurality of keys and a first plurality of values,
the first plurality of keys each being a corresponding identifier of corresponding object, the first plurality of keys including the first key, and
the first plurality of values each being a corresponding identifier of a corresponding container where the corresponding object is stored, the first plurality of values including a first value that is the identifier of the first container.

17. The non-transitory computer-readable medium of claim 16, wherein determining the IP address associated with the object protocol service provisioned to access the first container comprising the first object is performed by the object service proxy using the identifier of the first container as a second key to search a second key-value database to determine the IP address associated with the object protocol service, the second key-value database comprising:
a plurality of second key-value mappings between a second plurality of keys and a second plurality of values,
the second plurality of keys each being the corresponding identifier of the corresponding container where the corresponding object is stored, the second plurality of keys including the second key, and
the second plurality of values each being a corresponding IP address associated with a corresponding object protocol service provisioned to access the corresponding container, the second plurality of values including a second value that is the IP address associated with the object protocol service.

18. The non-transitory computer-readable medium of claim 15, wherein the operations further comprise:
receiving by the object service proxy, another request to create a second object;
determining, by the object service proxy, to create the second object in the first container in the object store;
determining, by the object service proxy, the IP address associated with the object protocol service provisioned to access the first container;
re-directing, by the object service proxy, the request to create the second object to the object protocol service using the IP address associated with the object protocol service; and
in response to re-directing the request to the object service proxy, receiving, by the object service proxy from the object protocol service, an indication that the second object has been created.

19. The non-transitory computer-readable medium of claim 18, wherein the object service proxy determines to create the second object in the first container in the object store based on:
an identifier of the first container included in the other request; or
a current usage of the percentage of the datastore capacity allocated to the object store.

20. The non-transitory computer-readable medium of claim 15, wherein the percentage of the datastore capacity leveraged by the object store is limited to a threshold amount.
